(19) United States
(12) Patent Application Publication
(10) Pub. No.: US 2024/0111711 A1
(43) Pub. Date: Apr. 4, 2024

(54) ARCHIVING DATA USING ADDITIONAL AUXILIARY DATABASE

(71) Applicant: SAP SE, Walldorf (DE)

(72) Inventor: Horst F. Schaude, Kraichtal (DE)

(21) Appl. No.: 17/957,433

(22) Filed: Sep. 30, 2022

(51) Int. Cl. G06F 16/11

(52) U.S. Cl. CPC G06F 16/113

(57) ABSTRACT

Techniques for archiving data using an additional auxiliary database are disclosed. In some embodiments, a computer system may store data in a primary database and archive the data stored in the primary database, where the archiving of the data comprises storing a first copy of the data in an archive database and storing a second copy of the data in an auxiliary database. Next, the computer system may detect a change to the primary database, determine that the detected change satisfies a condition, and, based on the determining that the detected change satisfies the condition, prevent the detected change from being applied to the archive database, and update the auxiliary database by applying the detected change to the auxiliary database. The computer system may then use the archive database to service a first type of request and the updated auxiliary database to service a second type of request.

### BACKGROUND

Data archiving is the process of moving data to a separate storage location for long-term retention. The data being archived may comprise data that is no longer actively used, but that is retained for future reference or regulatory compliance.

### BRIEF DESCRIPTION OF THE DRAWINGS

Some example embodiments of the present disclosure are illustrated by way of example and not limitation in the figures of the accompanying drawings, in which like reference numbers indicate similar elements.

FIG. 1 is an example network diagram illustrating a system.

FIG. 2 is a block diagram illustrating an example database management system.

FIG. 3 a flowchart illustrating an example method of archiving data using an additional auxiliary database.

FIG. 4 is a flowchart illustrating an example method of using an archive database to service a first type of request.

FIG. 5 is a flowchart illustrating an example method of using an updated auxiliary database to service a second type of request.

FIG. 6 is a block diagram of an example computer system on which methodologies described herein can be executed.

### DETAILED DESCRIPTION

Example methods and systems of archiving data using an additional auxiliary database are disclosed. In the following description, for purposes of explanation, numerous specific details are set forth in order to provide a thorough understanding of example embodiments. It will be evident, however, to one skilled in the art that the present embodiments can be practiced without these specific details.

Data may be archived to satisfy different objectives. However, aspects of these objectives may conflict with one another. For example, one objective may be to comply with legal or regulatory requirements, which may require that the archived data remain frozen and unaltered from the initial point in time of its archival, whereas another objective may be to use the archived data in a data restore process, which may require the archived data to be adapted or otherwise updated in accordance with changes made in a primary database in association with the data, such as a reorganization operation or a depersonalization operation having been performed for one or more entities associated with the data. Current data archiving solutions only maintain the archived data in a frozen state and do not adequately support its use in data restore operations and other use cases that require or benefit from updated archive data. Even if the frozen archive data is retrieved and then updated after retrieval in preparation for such use cases, such an approach is ineffective and inefficient, since there is insufficient execution time available for implementing the update of the retrieved archived data when performing certain operations. In addition to the issues discussed above, other technical problems may arise as well.

The implementation of the features disclosed herein involves a non-generic, unconventional, and non-routine operation or combination of operations. By applying one or more of the solutions disclosed herein, some technical effects of the system and method of the present disclosure are to archive data using an archive database for archiving data that is to remain frozen and an additional auxiliary database for archiving data that is to be updated based on changes made to the primary database. In some example embodiments, a computer system may store data in a primary database of a software application, and archive the data stored in the primary database by storing a first copy of the data in an archive database and storing a second copy of the data in an auxiliary database. Next, the computer system may detect a change to the primary database, determine that the detected change satisfies a condition, and, based on the determination that the detected change satisfies the condition, prevent the detected change from being applied to the archive database, and update the auxiliary database by applying the detected change to the auxiliary database. The computer system may then use the archive database to service a first type of request (e.g., a request to view the data for legal reasons) and use the updated auxiliary database to service a second type of request (e.g., a request to perform a data restore operation). By using the archive database to maintain the data in a frozen state and the additional auxiliary database to maintain the data in an updated state, the computer system provides a single data archival solution for effectively and efficiently satisfying multiple potentially-conflicting functional objectives. Other technical effects will be apparent from this disclosure as well.

The methods or embodiments disclosed herein may be implemented as a computer system having one or more modules (e.g., hardware modules or software modules). Such modules may be executed by one or more hardware processors of the computer system. In some example embodiments, a non-transitory machine-readable storage device can store a set of instructions that, when executed by at least one processor, causes the at least one processor to perform the operations and method steps discussed within the present disclosure.

The details of one or more variations of the subject matter described herein are set forth in the accompanying drawings and the description below. Other features and benefits of the subject matter described herein will be apparent from the description and drawings, and from the claims.

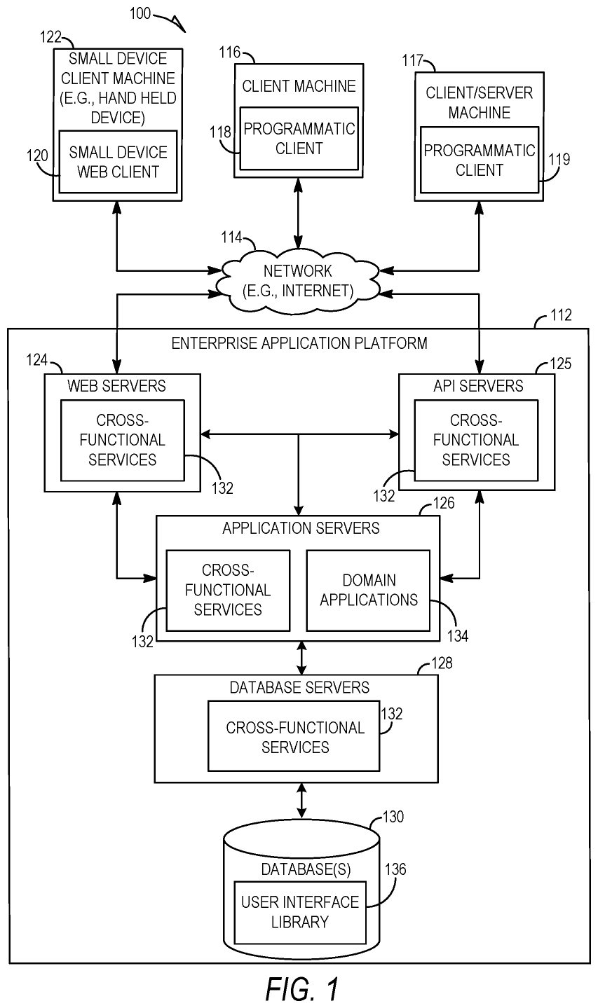

FIG. 1 is an example network diagram illustrating a system 100. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with a small device web client 120 (e.g., a browser without a script engine), and a client/server machine 117 with a programmatic client 119.

Turning specifically to the enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. The web servers 124, API servers 125, application servers 126, and database servers 128 can host cross-functional services 132. The cross-functional services 132 can include relational database modules to provide support services for access to the database(s) 130, which includes a user interface library 136. The application servers 126 can further host domain applications 134. The web servers 124 and the API servers 125 may be combined.

The cross-functional services 132 provide services to users and processes that utilize the enterprise application platform 112. For instance, the cross-functional services 132 can provide portal services (e.g., web services), database services, and connectivity to the domain applications 134 for users that operate the client machine 116, the client/server machine 117, and the small device client machine 122. In addition, the cross-functional services 132 can provide an environment for delivering enhancements to existing applications and for integrating third-party and legacy applications with existing cross-functional services 132 and domain applications 134. In some example embodiments, the system 100 comprises a client-server system that employs a client-server architecture, as shown in FIG. 1. However, the embodiments of the present disclosure are, of course, not limited to a client-server architecture, and could equally well find application in a distributed, or peer-to-peer, architecture system.

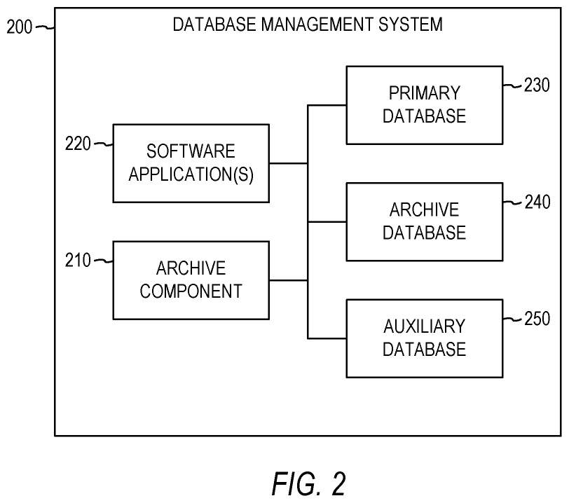

FIG. 2 is a block diagram illustrating an example database management system 200. The components shown in FIG. 2 may be configured to communicate with each other via one or more network connections. In some example embodiments, the database management system 200 comprises any combination of one or more of an archive component 210, one or more software applications 220, a primary database 230, an archive database 240, and an auxiliary database 250. One or more of the components of the database management system 200 may be implemented by the enterprise application platform 112 of FIG. 1. For example, the archive component 210 and the software application(s) 220 may be incorporated into the application server(s) 126, whereas the primary database 230, the archive database 240, and the auxiliary database 250 may be incorporated into the database(s) 130. However, the database management system 200 may be implemented in other ways as well. In some example embodiments, the primary database 230 may be configured to serve as a primary data storage for data of the software application(s) 220. Primary data storage is data storage that is used to capture and retain data that is in active use and frequently accessed by software applications and users.

The software application(s) 220 may comprise a cloud-based software application or an on-premise software application. Users may access and use the software application(s) 220 via computing devices (e.g., the client machine 116 or the small device client machine 122 in FIG. 1) that communicate with the software application(s) 220, such as via a network connection (e.g., the network 114 in FIG. 1). Furthermore, the software application(s) 220 may comprise enterprise resource planning (ERP) or other business management software that an organization can use to collect, store, manage, and interpret data from many business activities. The software application(s) 220 may also be configured to perform analytics functions, including, but not limited to, reporting, online analytical processing, analytics, data mining, process mining, complex event processing, predictive analytics, and prescriptive analytics. The software application(s) 220 may comprise other types and configurations of software applications as well. The software application(s) 220 may store any data that it creates or receives from a computing device of a user in the primary database 230. In some example embodiments, the primary database 230 comprises an in-memory database. However, the primary database 230 may comprise other types of databases or data storage.

The archive component 210 may be configured to archive the data stored in the primary database 230. The archiving of the data may comprise storing a copy of the data in the archive database 240 and storing another copy of the data in the auxiliary database 250. The data from the primary database 230 may be copied to the archive database 230 and to the auxiliary database 240 simultaneously or in parallel. In some example embodiments, the archive component 210 may perform the archiving of the data periodically (e.g., daily, weekly, monthly). However, the archive component 210 may alternatively perform the archiving of the data in response to an explicit user instruction, in response to a determination that a threshold amount of data storage space has been consumed in the primary database 230, or in response to some other determination about the status or health of the primary database 230.

The archive database 240 may be configured to persist a copy of the primary database 230 in a frozen state that is not updated, whereas the auxiliary database 240 may be configured to persist an updated version of the primary database 230 that adapts to certain changes that are applied to the primary database 230. For example, when a reorganization operation has been performed for one or more entities associated with the data in the primary database 230, such as a change in assets, liabilities, departments, employees, or products of an organization, the archive component 210 may apply the same change that is implemented in the primary database 230 by the reorganization operation to the auxiliary database 250, thereby resulting in the auxiliary database 250 mirroring the primary database 230, but the archive database 240 may remain unaltered in its frozen state. In another example, when a depersonalization operation has been performed for one or more entities associated with the data in the primary database 230, such as the removal or obscuring of personal data (e.g., names, addresses, phone numbers), the archive component 210 may apply the same depersonalization operation to the auxiliary database 250, thereby resulting in the auxiliary database 250 mirroring the primary database, but the archive database 240 may remain unaltered in its frozen state. Other types of changes to the primary database 230, such as other changes to system settings of the primary database 240, may similarly result in the mirroring of those changes in the auxiliary database 250, but not in the archive database 240.

In some example embodiments, the archive component 210 is configured to detect a change to the primary database 230. For example, the archive component 210 may detect the change to the primary database 230 by receiving a communication from the database management system 200 identifying the change. In another example, the archive component 210 may detect the change to the primary database 230 by monitoring or periodically scanning metadata of the primary database 230 for an indication of any changes to the primary database 230. The archive component 210 may detect the change to the primary database 230 in other ways as well.

The archive component 210 may determine that the detected change satisfies a condition. The condition may comprise the detected change comprising the execution of an operation that is included in a group of operations. For example, if the detected change comprises a reorganization operation having been performed for one or more entities associated with the data or a data depersonalization operation having been performed for one or more entities associated with the data, then the archive component 210 may determined that the detected change satisfies the condition. Other types and configurations of the group of operations or the condition are also within the scope of the present disclosure. The archive component 210 may be configured to, in response to or otherwise based on the determination that the detected change satisfies the condition, prevent the detected change from being applied to the archive database 240, and update the auxiliary database 250 by applying the detected change to the auxiliary database 250. The archive component 210 may be configured to use the archive database 240 (and not the updated auxiliary database 250) to service a first type of request or a first grouping of requests, but to use the updated auxiliary database 250 (and not the archive database 240) to service a second type of request different from the first type of request or a second grouping of requests different from the first grouping of requests. For example, the archive component 210 may be configured to receive a request from a computing device to view the data, and, in response to or otherwise based on the receiving of the request to view the data, retrieve the first copy of the data from the archive database 240 and cause the retrieved first copy of the data to be displayed on the computing device. In another example, the archive component 210 may be configured to receive a request to perform a data restore operation for the primary database 230, and, in response to or otherwise based on the receiving of the request to perform the data restore operation for the primary database 230, retrieve the second copy of the data from the updated auxiliary database 250 and perform the data restore operation for the primary database 230 using the retrieved second copy of the data, such as by copying the retrieved second copy of data back to the primary database 230.

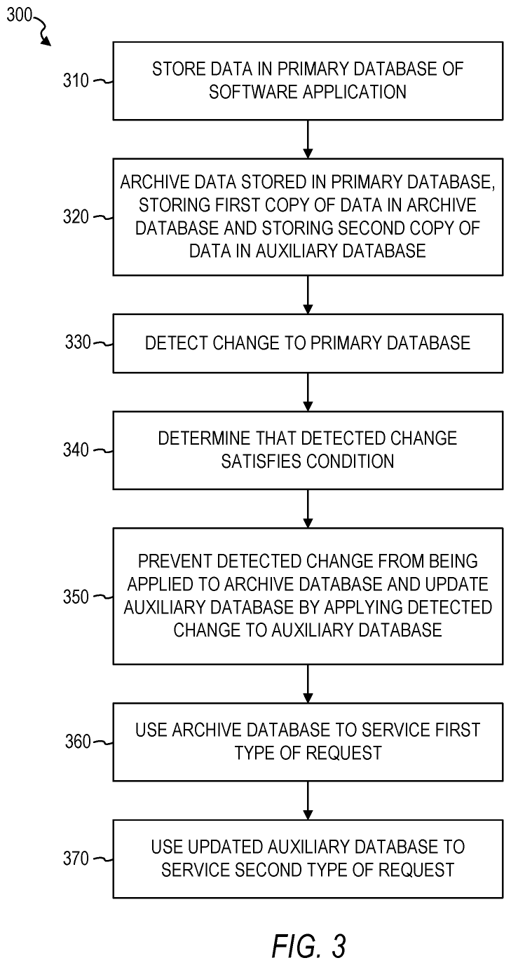

FIG. 3 a flowchart illustrating an example method 300 of archiving data using an additional auxiliary database. The method 300 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 300 are performed by the database management system 200 of FIG. 2 or any combination of one or more of its components (e.g., the archive component 210).

At operation 310, the database management system 200 may store data in a primary database 230 of a software application 220. The primary database 230 may comprise an in-memory database. However, the primary database 230 may comprise other types of databases as well.

The database management system 200 may then, at operation 320, archive the data stored in the primary database 230. The archiving of the data may comprise storing a first copy of the data in an archive database 240 and storing a second copy of the data in an auxiliary database 250. In some example embodiments, the database management system 200 may perform the archiving of the data as part of a recurring archiving operation that is performed periodically. However, it is contemplated that the archiving of the data may be triggered in other ways as well.

Next, the database management system 200 may detect a change to the primary database, at operation 330. For example, the database management system 200 may detect the change to the primary database 230 by receiving a communication identifying the change or by monitoring metadata of the primary database 230 for an indication of any changes to the primary database 230. Other ways of detecting the change to the primary database 230 may also be used by the database management system 200.

At operation 340, the database management system 200 may determine that the detected change satisfies a condition. In some example embodiments, the condition may comprise the change comprising a reorganization operation having been performed for one or more entities associated with the data or the change comprising a data depersonalization operation having been performed for one or more entities associated with the data. However, other configurations of the condition are also within the scope of the present disclosure.

Then, the database management system 200 may, at operation 350, update the auxiliary database 250 by applying the detected change to the auxiliary database 250, but prevent the detected change from being applied to the archive database 240, in response to or otherwise based on the determining that the detected change satisfies the condition, As a result, the data in the auxiliary database 250 mirrors the primary database 230 for every change that satisfies a particular criteria, while the data in the archive database 240 remains unaltered in a frozen state. Next, at operation 360, the database management system 200 may use the archive database 240 to service a first type of request. For example, the database management system 200 may determine that a received request is included in a first group of requests, and, in response to or otherwise based on that determination, use the archive database 240 (and not the updated auxiliary database 250) to service the request.

At operation 370, the database management system 200 may use the updated auxiliary database 250 to service a second type of request. For example, the database management system 200 may determine that a received request is included in a second group of requests, and, in response to or otherwise based on that determination, use the updated auxiliary database 250 (and not the archive database 240) to service the request.

It is contemplated that any of the other features described within the present disclosure can be incorporated into the method 300.

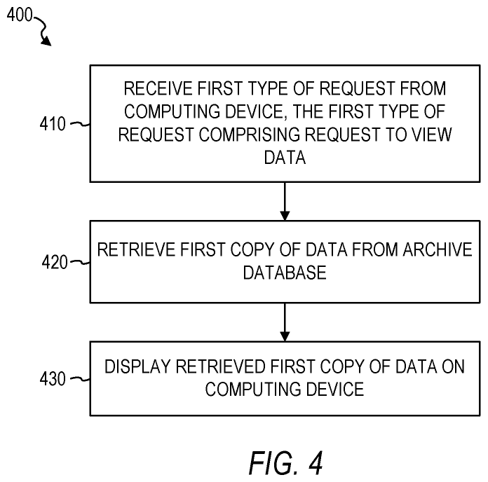

FIG. 4 is a flowchart illustrating an example method 400 of using an archive database to service a first type of request. The method 400 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 400 are performed by the database management system 200 of FIG. 2 or any combination of one or more of its components (e.g., the archive component 210).

At operation 410, the database management system 200 may receive the first type of request from a computing device. The first type of request may comprise a request to view the data. However, the first type of request may comprise other types of requests as well.

Next, the database management system 200 may, in response to the receiving the first type of request, retrieving the first copy of the data from the archive database 240, at operation 420. For example, the database management system 200 may identify the type of the request as being of the first type based on metadata or content of the request, and then, based on the identification of the type of the request as being of the first type, retrieve the first copy of the data from the archive database 240.

The database management system 200 may then, at operation 430, cause the retrieved first copy of the data to be displayed on the computing device or perform some other operation requested by the first type of request. For example, the database management system 200 may transmit the retrieved first copy of the data to the computing device along with an instruction to display the retrieved first copy of the data.

It is contemplated that any of the other features described within the present disclosure can be incorporated into the method 400.

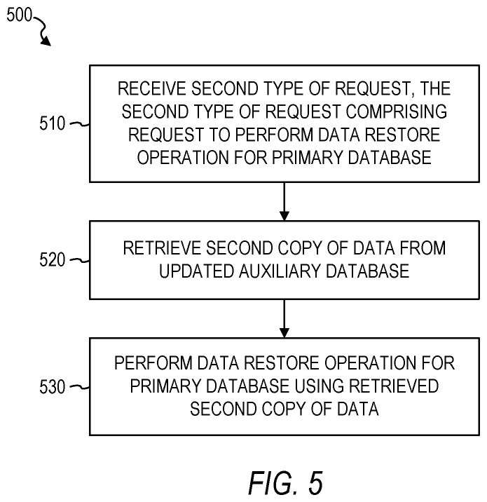

FIG. 5 is a flowchart illustrating an example method 500 of using an updated auxiliary database to service a second type of request. The method 500 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 500 are performed by the database management system 200 of FIG. 2 or any combination of one or more of its components (e.g., the archive component 210).

At operation 510, the database management system 200 may receive the second type of request. The second type of request comprising a request to perform a data restore operation for the primary database 230. However, the second type of request may comprise other types of requests as well.

Next, the database management system 200 may, in response to the receiving the second type of request, retrieve the second copy of the data from the updated auxiliary database, at operation 520. For example, the database management system 200 may identify the type of the request as being of the second type based on metadata or content of the request, and then, based on the identification of the type of the request as being of the second type, retrieve the second copy of the data from the updated auxiliary database 250.

The database management system 200 may then, at operation 530, perform the data restore operation for the primary database using the retrieved second copy of the data or perform some other operation requested by the second type of request. For example, the database management system 200 may copy the retrieved second copy of data back to the primary database 230.

It is contemplated that any of the other features described within the present disclosure can be incorporated into the method 500.

In view of the disclosure above, various examples are set forth below. It should be noted that one or more features of an example, taken in isolation or combination, should be considered within the disclosure of this application.

Example 1 includes a computer-implemented method performed by a computer system having a memory and at least one hardware processor, the computer-implemented method comprising: storing data in a primary database of a software application; archiving the data stored in the primary database, the archiving of the data comprising storing a first copy of the data in an archive database and storing a second copy of the data in an auxiliary database; detecting a change to the primary database; determining that the detected change satisfies a condition; based on the determining that the detected change satisfies the condition, preventing the detected change from being applied to the archive database, and updating the auxiliary database by applying the detected change to the auxiliary database; using the archive database to service a first type of request; and using the updated auxiliary database to service a second type of request.

Example 2 includes the computer-implemented method of example 1, wherein the primary database comprises an in-memory database.

Example 3 includes the computer-implemented method of example 1 or example 2, wherein the archiving the data is performed as part of a recurring archiving operation that is performed periodically.

Example 4 includes the computer-implemented method of any one of examples 1 to 3, wherein the condition comprises the change comprising a reorganization operation having been performed for one or more entities associated with the data.

Example 5 includes the computer-implemented method of any one of examples 1 to 4, wherein the condition comprises the change comprising a data depersonalization operation having been performed for one or more entities associated with the data.

Example 6 includes the computer-implemented method of any one of examples 1 to 5, wherein the using the archive database to service the first type of request comprises: receiving the first type of request from a computing device, the first type of request comprising a request to view the data; in response to the receiving the first type of request, retrieving the first copy of the data from the archive database; and causing the retrieved first copy of the data to be displayed on the computing device.

Example 7 includes the computer-implemented method of any one of examples 1 to 6, wherein the using the updated second backup database to service the second type of request comprises: receiving the second type of request, the second type of request comprising a request to perform a data restore operation for the primary database; in response to the receiving the second type of request, retrieving the second copy of the data from the updated auxiliary database; and performing the data restore operation for the primary database using the retrieved second copy of the data

Example 8 includes a system comprising: at least one processor; and a non-transitory computer-readable medium storing executable instructions that, when executed, cause the at least one processor to perform the method of any one of examples 1 to 7.

Example 9 includes a non-transitory machine-readable storage medium, tangibly embodying a set of instructions that, when executed by at least one processor, causes the at least one processor to perform the method of any one of examples 1 to 7.

Example 10 includes a machine-readable medium carrying a set of instructions that, when executed by at least one processor, causes the at least one processor to carry out the method of any one of examples 1 to 7.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

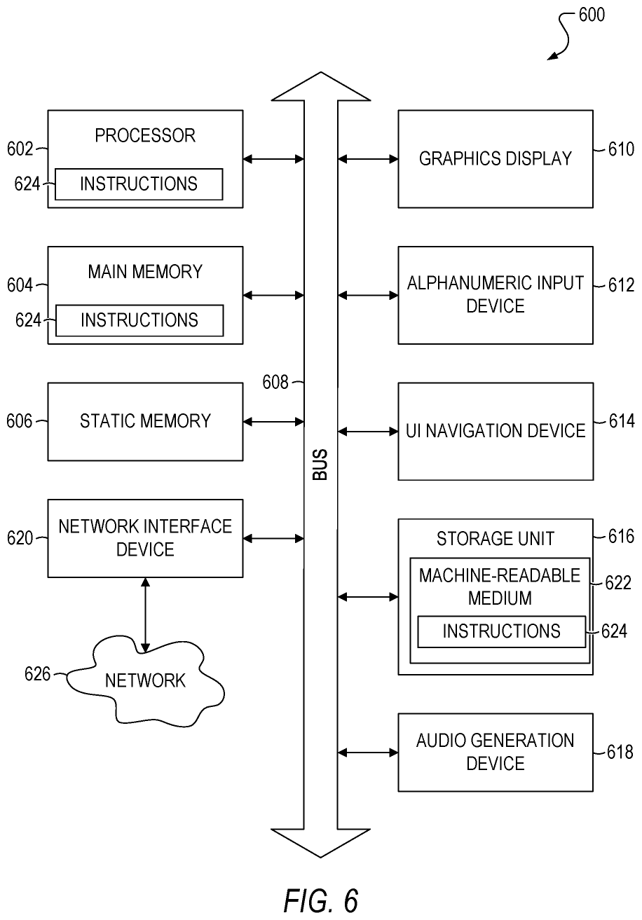

FIG. 6 is a block diagram of a machine in the example form of a computer system 600 within which instructions 624 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604, and a static memory 606, which communicate with each other via a bus 608. The computer system 600 may further include a graphics or video display unit 610 (e.g., a liquid crystal display (LCD) or a cathode ray tube (CRT)). The computer system 600 also includes an alphanumeric input device 612 (e.g., a keyboard), a user interface (UI) navigation (or cursor control) device 614 (e.g., a mouse), a storage unit (e.g., a disk drive unit) 616, an audio or signal generation device 618 (e.g., a speaker), and a network interface device 620.

The storage unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may also reside, completely or at least partially, within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMAX networks). The term “transmission medium” shall be taken to include any intangible medium capable of storing, encoding, or carrying instructions for execution by the machine, and includes digital or analog communications signals or other intangible media to facilitate communication of such software.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method performed by a computer system comprising a memory and at least one hardware processor, the computer-implemented method comprising:
storing data in a primary database of a software application;
archiving the data stored in the primary database, the archiving of the data comprising storing a first copy of the data in an archive database and storing a second copy of the data in an auxiliary database;
detecting a change to the primary database;
determining that the detected change satisfies a condition;
based on the determining that the detected change satisfies the condition, preventing the detected change from being applied to the archive database, and updating the auxiliary database by applying the detected change to the auxiliary database;
using the archive database to service a first type of request; and
using the updated auxiliary database to service a second type of request.

2. The computer-implemented method of claim 1, wherein the primary database comprises an in-memory database.

3. The computer-implemented method of claim 1, wherein the archiving the data is performed as part of a recurring archiving operation that is performed periodically.

4. The computer-implemented method of claim 1, wherein the condition comprises the change comprising a reorganization operation having been performed for one or more entities associated with the data.

5. The computer-implemented method of claim 1, wherein the condition comprises the change comprising a data depersonalization operation having been performed for one or more entities associated with the data.

6. The computer-implemented method of claim 1, wherein the using the archive database to service the first type of request comprises:
receiving the first type of request from a computing device, the first type of request comprising a request to view the data;
in response to the receiving the first type of request, retrieving the first copy of the data from the archive database; and
causing the retrieved first copy of the data to be displayed on the computing device.

7. The computer-implemented method of claim 1, wherein the using the updated auxiliary database to service the second type of request comprises:
receiving the second type of request, the second type of request comprising a request to perform a data restore operation for the primary database;
in response to the receiving the second type of request, retrieving the second copy of the data from the updated auxiliary database; and
performing the data restore operation for the primary database using the retrieved second copy of the data.

8. A system of comprising:
at least one hardware processor; and
a non-transitory computer-readable medium storing executable instructions that, when executed, cause the at least one processor to perform computer operations comprising:
storing data in a primary database of a software application;
archiving the data stored in the primary database, the archiving of the data comprising storing a first copy of the data in an archive database and storing a second copy of the data in an auxiliary database;
detecting a change to the primary database;
determining that the detected change satisfies a condition;
based on the determining that the detected change satisfies the condition, preventing the detected change from being applied to the archive database, and updating the auxiliary database by applying the detected change to the auxiliary database;
using the archive database to service a first type of request; and
using the updated auxiliary database to service a second type of request.

9. The system of claim 8, wherein the primary database comprises an in-memory database.

10. The system of claim 8, wherein the archiving the data is performed as part of a recurring archiving operation that is performed periodically.

11. The system of claim 8, wherein the condition comprises the change comprising a reorganization operation having been performed for one or more entities associated with the data.

12. The system of claim 8, wherein the condition comprises the change comprising a data depersonalization operation having been performed for one or more entities associated with the data.

13. The system of claim 8, wherein the using the archive database to service the first type of request comprises:
receiving the first type of request from a computing device, the first type of request comprising a request to view the data;
in response to the receiving the first type of request, retrieving the first copy of the data from the archive database; and
causing the retrieved first copy of the data to be displayed on the computing device.

14. The system of claim 8, wherein the using the updated auxiliary database to service the second type of request comprises:
receiving the second type of request, the second type of request comprising a request to perform a data restore operation for the primary database;
in response to the receiving the second type of request, retrieving the second copy of the data from the updated auxiliary database; and
performing the data restore operation for the primary database using the retrieved second copy of the data.

15. A non-transitory machine-readable storage medium tangibly embodying a set of instructions that, when executed by at least one hardware processor, causes the at least one processor to perform computer operations comprising:
storing data in a primary database of a software application;
archiving the data stored in the primary database, the archiving of the data comprising storing a first copy of the data in an archive database and storing a second copy of the data in an auxiliary database;
detecting a change to the primary database;
determining that the detected change satisfies a condition;
based on the determining that the detected change satisfies the condition, preventing the detected change from being applied to the archive database, and updating the auxiliary database by applying the detected change to the auxiliary database;
using the archive database to service a first type of request; and
using the updated auxiliary database to service a second type of request.

16. The non-transitory machine-readable storage medium of claim 15, wherein the archiving the data is performed as part of a recurring archiving operation that is performed periodically.

17. The non-transitory machine-readable storage medium of claim 15, wherein the condition comprises the change comprising a reorganization operation having been performed for one or more entities associated with the data.

18. The non-transitory machine-readable storage medium of claim 15, wherein the condition comprises the change comprising a data depersonalization operation having been performed for one or more entities associated with the data.

19. The non-transitory machine-readable storage medium of claim 15, wherein the using the archive database to service the first type of request comprises:
receiving the first type of request from a computing device, the first type of request comprising a request to view the data;
in response to the receiving the first type of request, retrieving the first copy of the data from the archive database; and
causing the retrieved first copy of the data to be displayed on the computing device.

20. The non-transitory machine-readable storage medium of claim 15, wherein the using the updated auxiliary database to service the second type of request comprises:
receiving the second type of request, the second type of request comprising a request to perform a data restore operation for the primary database;
in response to the receiving the second type of request, retrieving the second copy of the data from the updated auxiliary database; and
performing the data restore operation for the primary database using the retrieved second copy of the data.
